(19) United States
(12) Patent Application Publication
(10) Pub. No.: US 2024/0067111 A1
(43) Pub. Date: Feb. 29, 2024

(54) VEHICLE BUMPER AND FRAME ATTACHMENTS AND METHODS FOR MAKING THE SAME

(71) Applicant: Patrick Timothy Yerby, JR., Lynchburg, VA (US)

(72) Inventor: Patrick Timothy Yerby, JR., Lynchburg, VA (US)

(21) Appl. No.: 18/237,356

(22) Filed: Aug. 23, 2023

Related U.S. Application Data
(60) Provisional application No. 63/400,451, filed on Aug. 24, 2022.

(51) Int. Cl. B60R 19/02

(52) U.S. Cl. CPC B60R 19/023

(57) ABSTRACT

A panel configured to convert from a flat configuration to a folded configuration includes a central section, a first intermediate section, a second intermediate section, a first outer section, and a second outer section. The first intermediate section and the second intermediate section are formed on opposite sides of the central section and are foldable relative to the central section. The first outer section is formed on a side of the first intermediate section opposite the central section and is foldable relative to the first intermediate section. The second outer section is formed on a side of the second intermediate section opposite the central section and is foldable relative to the second intermediate section. The panel can be folded along a plurality of intended bend lines to be converted to the folded configuration and includes a slot or a perforation line defined therein along one or more of the intended bend lines.

### CROSS-REFERENCE TO RELATED APPLICATION

This application claims priority to and benefit of U.S. Provisional Patent Application No. 63/400,451 filed Aug. 24, 2022, which is hereby incorporated by reference herein in its entirety.

### TECHNICAL FIELD

The subject matter disclosed herein is generally directed to improved fabricated structural parts for vehicles (or other machines or objects) and methods for making same. In one instance, an improved fabricated metal vehicle bumper is disclosed comprising a defined panel cut from a single piece of sheet metal and configured so that the sheet metal can be bent and connected to form a final shape intended for use as a vehicle bumper. The panel includes perforations and slots in the sheet metal along the intended bend lines to reduce the amount of metal that needs to be bent, thereby reducing the force required to bend in to the desired shape

### BACKGROUND

Fabricated metal bumpers are a popular aftermarket add on accessory for trucks and SUV's globally. These fabricated metal bumpers are typically fabricated from a number of sheet metal segments that are fixtured in to position and welded along the seams. A significant, if not a majority, of the amount of the fabrication labor is involved in the fixturing of the segments. Additionally, fabricated metal bumpers often require folded or bent components, which require heavy duty machinery to complete the bends in the correct position with the correct angle. The folded and fixtured components are subject to heat distortion during the welding process, therefore the fixturing often needs to be substantial to prevent the final fabricated bumper from being distorted from the intended design.

One identified difficulty with existing products is the use of multi-component products. This requires significant supply chain organization during the manufacturing process to assure the correct number of components are delivered to the assembly process or in the case of DIY kits to the customer. Another identified difficulty with existing products is the requirement established by the design for folded pieces through the use of heavy tonnage sheet metal bending equipment. A further identified difficulty with existing products the use of tabs and slots for aligning folded panels that are adjacent to each other. This tab and slot arrangement does not securely engage the adjacent panel, if panels are on similar planes, and may allow panels to separate during subsequent welding processes due to heat warpage. An additional identified difficulty with existing products is the use of welded joints at structural joints. Welds used as structural fastening should be minimized from an engineering perspective due to wide variation in the quality of welds experienced due to materials, processes, and techniques used. An even further identified difficulty with existing products is with the gap at the adjacent panels. In the closed end slits of prior attempts, limited consideration is made of the dimensions of the slits post bending. Some prior efforts disclose slits having a kerf width dimensioned producing inter-engagement of solid edges of said sheet of material on opposite sides of said slits during bending.

Accordingly, it is an object of the present disclosure to eliminate the problems present with prior attempts. The current disclosure provides an integral, foldable, self-fixturing one piece design construction, eliminating the need for multiple components allowing for bending and connecting to form a final shape employing perforations and slots to reduce the amount of metal requiring bending and the force required to bend same.

Citation or identification of any document in this application is not an admission that such a document is available as prior art to the present disclosure.

### SUMMARY

The term embodiment and like terms, e.g., implementation, configuration, aspect, example, and option, are intended to refer broadly to all the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

The above objectives are accomplished according to the present disclosure by providing, in one instance, improved fabricated structural parts for vehicles employing a defined panel cut from a single piece and configured to be bent and connected to form a final shape intended for use on a vehicle via employing perforations and slots along the intended bend lines to reduce the amount of materials requiring bending, thereby reducing the force required to bend the material into the desired shape.

In another instance, the current disclosure provides methods for making improved fabricated structural parts for vehicles employing a defined panel cut from a single piece and configured to be bent and connected to form a final shape intended for use on a vehicle via employing perforations and slots along the intended bend lines to reduce the amount of materials requiring bending, thereby reducing the force required to bend the material into the desired shape.

According to some implementations of the present disclosure, a panel that is configured to be converted from a generally flat configuration to a folded configuration to form a structural element for a vehicle includes a central section, a first intermediate section, a second intermediate section, a first outer section, and a second outer section. The first intermediate section and the second intermediate section are formed on opposite sides of the central section. The first intermediate section and the second intermediate section are foldable relative to the central section. The first outer section is formed on a side of the first intermediate section opposite from the central section and is foldable relative to the first intermediate section. The second outer section is formed on a side of the second intermediate section opposite from the central section and is foldable relative to the second intermediate section. The panel is configured to be folded along a plurality of intended bend lines to be converted to the folded configuration and includes a slot or a perforation line defined therein along each of the intended bend lines.

According to some implementations of the present disclosure, a method of assembling a structural element (e.g., a structural element of a vehicle or other machine or object) includes providing a panel that includes a plurality of sections integrally formed together to form a single piece of material. The panel is foldable along a plurality of intended being lines and includes a slot or a perforation defined therein along each of the plurality of intended bend lines. The method further includes folding the panel along the plurality of intended bend lines to convert the panel to a folded configuration. The method further includes securing the panel in its folded configuration by: (i) inserting a tab of one panel into a tab receiver defined in another panel; (ii) inserting a first bolt through overlapping bolt holes defined in an adjacent pair of panels; (iii) inserting a second bolt through overlapping bolt holes defined in one panel; or (iv) any combination of (i)-(iii).

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out aspects of the present disclosure, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments and are therefore not to be considered as limitations on the scope of the various embodiments or claims.

FIG. 1 is a view of a structural panel in an unfolded configuration, according to aspects of the present disclosure.

FIG. 2A is a close-up view of an outer section of the structural panel of FIG. 1 when the structural panel is in the unfolded configuration, according to aspects of the present disclosure.

FIG. 2B is a close-up view of the outer section of FIG. 2A when the structural panel is in a folded configuration, according to aspects of the present disclosure.

FIG. 3A is a close-up view of an intermediate section of the structural panel of FIG. 1 when the structural panel is in the unfolded configuration, according to aspects of the present disclosure.

FIG. 3B is a close-up view of the intermediate section of FIG. 3A when the structural panel is in a folded configuration, according to aspects of the present disclosure.

FIG. 4A is a view of the structural panel of FIG. 1 in the folded configuration, according to aspects of the present disclosure.

FIG. 4B is a view an end of the outer section of the structural panel when the structural panel is in the folded configuration, according to aspects of the present disclosure.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/of” unless expressly stated otherwise. Similarly, a group of items linked with the conjunction “or” should not be read as requiring mutual exclusivity among that group, but rather should also be read as “and/of” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

The present disclosure seeks to improve the manufacturability of structural components for vehicles through improved design for manufacturing by both overcoming limitations with prior efforts and reducing or eliminating difficulties in existing products and manufacturing processes.

Recently, advances in precision metal cutting using lasers and water jet machinery have resulted in a reduction in fabricated metal component fixturing time through the use of precision cut tabs and slots in the metal components, allowing component pieces to be assembled by pushing tabs and slots in to the mating pieces for alignment prior to welding.

To overcome the failings and limitations of prior efforts, the present disclosure incorporates an integral, foldable, self-fixturing one piece design construction, eliminating the need for multiple components. In one instance, the present disclosure provides integral, folded mounting brackets, thereby eliminating separate mounting bracket components required by existing products. The present disclosure also overcomes prior efforts through the use of closed ended slots at the fold line, with remaining material dimensions precisely designed so that pieces can be folded using normal clamping hand tools by adult humans, with forces typically in the range of 5-50 lbs. The current disclosure also seeks to address prior effort limitations through utilization of dovetail type engagement shapes so that once the adjacent pieces are folded in to the correct position they cannot unfold due to heat, and the strength of the folded member is not entirely dependent on the weld strength but is enhanced by the interlocking dovetails. The present disclosure also provides post-folding slit dimensions optimized for full penetration welding by creating post folded slits with gaps on the posterior side optimized for full penetration welding based on the material thickness used. Folded slits would have a small opening on the posterior and a large opening on the anterior, facilitating filling the slot with weld material with minimal effort. In addition, the current disclosure also provides the use of folded tabs with through bolt holes, enabling the use of bolted fasteners to assemble, tighten, and align adjacent pieces while also adding structural strength to the assembling in addition to the welded joints.

In one instance, the current disclosure provides an improved fabricated metal vehicle bumper. The bumper comprises a defined panel cut from a single piece of sheet metal. The panel is configured so that the sheet metal can be bent and connected to form a final shape intended for use as a vehicle bumper. The panel includes perforations and slots in the sheet metal along the intended bend lines to reduce the amount of metal that needs to be bent, thereby reducing the force required to bend in to the desired shape. The panel also includes mating interlocking shapes that hold folded sections of the panel together through engagement of the interlocking shapes, which may be dovetails, as known to those of skill in the art, and increase structural rigidity in the final bumper. These mating interlocking dovetail shapes may take any number of different forms including ovals, semi-circles, trapezoids, and their shapes as commonly known. The panel also includes sections that form vehicle mounting brackets once folded in to final position. The panel also includes integral bolt holes to facilitate alignment and allow fastening of adjacent folded sections to increase structural rigidity of the final bumper. The perforations and slots of the panel may be dimensioned so that when the sections are folded the perforation or slot is closed facilitating fillet welding.

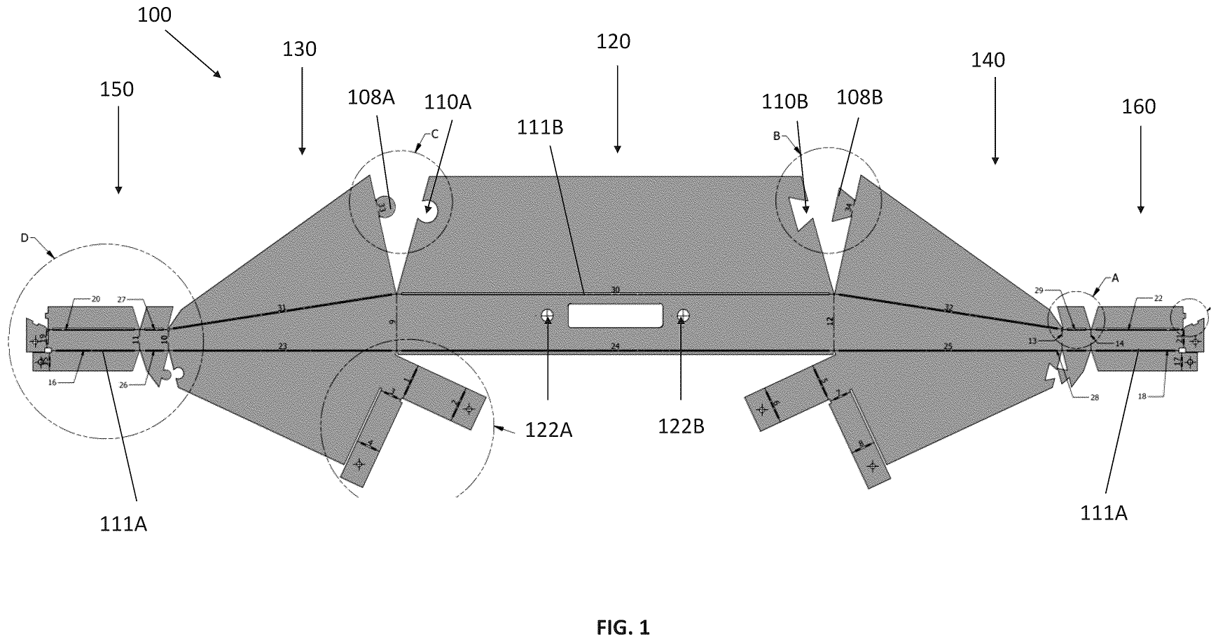

FIG. 1 shows a structural panel 100 of the current disclosure in a generally flat configuration prior to any bending or manipulation of structural panel 100. The panel 100 can be converted to a folded configuration. In some implementations, the panel 100 in its folded configuration forms a bumper or other structural component of a vehicle that can be attached once folded/assembled, such as a grill guard or a skid plate. However, the panel 100 can be used to form structural elements of generally any machine, object, device, etc. The panel 100 can be formed from any suitable material, such as metal (e.g., sheet metal), plastic, composite, combinations of materials, etc.

In the illustrated implementation, the panel 100 includes a central section 120, two intermediate sections 130 and 140, and two outer sections 150 and 160. Intermediate section 130 is positioned between central section 120 and outer section 150. Intermediate section 140 is positioned between central section 120 and outer section 160. In some implementations, the panel 100 is formed from a single continuous piece of material, and all of these sections are integrally attached. In other implementations, the panel 100 may be formed form multiple pieces of material, and some of the sections may be formed separately and then attached to each other. Portions of each respective section can be folded relative to other portions of the respective sections, and the sections themselves can be folded relative to themselves, in order to convert the panel 100 to its final configuration. The panel 100 is thus configured to be folded along a plurality of intended bend lines to convert to the folded configuration. The panel 100 can include a perforation line or a slot defined therein along one or more of the intended bend lines, which aids a user in converting the panel 100 to the folded configuration by reducing the amount of force required to bend the panel 100 along the intended bend lines.

In general, the intended bend lines are not an actual physical feature of the panel 100, but rather just refer to the location along the panel 100 where a bend is needed. The intended bend lines may be included in a document (such as a blueprint, engineering or technical drawing, specification, etc.) that visually depicts the panel 100. However, in some implementations, the intended bend lines could be formed on the actual panel 100 itself to provide a user or technician a visual indication of where the panel 100 needs to bend. In these implementations, the intended bend line would be formed aligned with the slot or perforation that is defined in the panel 100. The intended bend lines could be formed in any suitable fashion, for example by using a laser to physically inscribe the intended bend lines into the surface of the panel 100.

The perforation lines generally include a series of small apertures intermittently formed partially or fully through the panel 100 in a straight line, a series of straight lines, a curve line, a series of curved lines, or any combination of these or other arrangement. The removal of the material of the panel 100 by these perforations reduces the amount of force required to bend the panel 100 along the perforation lines. The slots are larger continuous openings formed partially or fully through the panel 100. The slots can be straight, curved, or have any other arrangement. Similar to the perforation lines, the removal of the material of the panel 100 by the slots reduces the amount of force required to bend the panel 100 along the slots. The perforation lines and the slots are generally sized so that they are suitable for fillet welding after the panel 100 is been folded. In some implementations, perforation lines can be used for intended bend lines where the panel 100 is thinner, as the interspersed material of the panel 100 formed by the individual apertures of the perforation line can aid in maintaining the material shape of the panel 100 when bending (e.g., aiding in maintaining the integrity of the material of the panel 100). In some implementations, slots can be used for intended bend lines where the panel 100 is thicker and a greater bending force would be required to bend the panel 100 along the intended bend lines, as more of the material of the panel 100 may need to be removed to lessen the required being force.

As discussed in more detail herein, each of the sections is generally foldable relative to both itself, and to each adjacent section. Thus, the central section 120 can itself be folded, and can be folded relative to both of the intermediate sections 130 and 140. Both of the intermediate section 130 and 140 can be folded, and are each able to be folded relative to the central section 120 and one of the outer section 150 and 160. Finally, both of the outer sections 150 and 160 can be folded, and are able to be folded relative to the intermediate sections 130 and 140. An example slot 111A is formed along an intended bend line in the outer sections 150, and an example perforation line 111B is formed along an intended bend line in the central section 120. However, any intended bend line in the panel 100 could include a perforation line or a slot (or a combination of both) depending on the design of the panel 100. Moreover, some intended bend lines may not include a perforation line or a slot. In general, the panel 100 may include, along any given intended bend line of the panel 100, whether the intended bend line is located at an intersection of two adjacent sections or within a single section, a slot and/or a perforation defined therein.

FIG. 1 also shows interlocking tabs and tab receivers of the panel 100. The intermediate section 130 of the panel 100 includes an arc-shaped tab 108A extending toward the central section 120. The central section 120 includes a corresponding arc-shaped tab receiver 110A defined therein that is sized to receive the tab 108A. Similar to intermediate section 130, intermediate section 140 of the panel 100 includes an trapezoid-shaped tab 108B extending toward the central section 120. The central section 120 includes a corresponding trapezoid-shaped tab receiver 110B defined therein that is sized to receive the tab 108B. While the intermediate sections 130 and 140 are already attached to the central section 120 (e.g., integrally formed with the central section 120), when the panel 100 is folded as required to form its final configuration, the tabs 108A and 108B and the tab receivers 110A and 110B interact with each other to interlock the central section 120 with the intermediate sections 130 and 140 in the folded configuration, to aid in retaining the panel 100 in its folded configuration. The material forming the panel 100 will generally resist bending to some degree, and the reception of the tabs 108A, 108B in the corresponding tab receivers 110A, 110B aids in retaining adjacent sections/surfaces of the panel 100 together when the panel 100 is in the folded configuration.

Each tab receiver will have generally the same shape as its corresponding tab, so that each tab receiver can receive its corresponding tab therein. However, the tabs and tab receivers are shaped so that once the tab is received within the tab receiver, the tab is unable to be removed from the tab receiver in response to the different sections of the panel 100 being pulled apart in opposite directions. The tabs have a dovetail shape where the maximum dimension of the tab is larger than the width of the opening of the corresponding tab receiver. Thus, each tab receiver can receive its corresponding tab by aligning the tab and the tab receiver so that their shapes are aligned, and then inserting the corresponding tab from above or below. Once this occurs, the tabs cannot be inadvertently pulled out of the tab receiver by being pulled directly apart, because the maximum dimension of the tab is larger than the width of the opening of the tab receiver. The panel 100 also includes bolt holes 122A and 122B defined in the central section 120 that allow the central section 120 to be fastened to other sections and/or to a vehicle. While FIG. 1 shows that one of the pair of tabs and tab receivers is arc-shaped and the other is trapezoid-shaped, other dovetail-like shapes can be used as well.

The tabs and the tab receivers can generally be any size. In some implementations, the maximum dimension of the tabs is between about 1 inch and about 3 inches, and the width of the opening of the tab receiver will be slightly smaller. The size of the tabs and tab receivers may depend on the material forming the panel 100 and/or the arrange of the panel 100 in its folded configuration. For example, if the panel 100 is formed from a material that tends to resist the bending/folding of the panel 100 to a larger degree, the tabs and tab receivers may be relatively larger so as to provide more force to securing the panel 100 in its folded configuration. In another example, if the panel 100 is formed from a material that tends to resist the bending/folding of the panel 100 to a smaller degree, the tabs and tab receivers can be relatively smaller, as they do not need to provide as much force to secure the panel 100 in its folded configuration. In some implementations, the tabs and tab receivers may not have a dovetail shape (e.g., arc-shaped or triangular-shaped), but may instead have a rectangular/square shape, as discussed in more detail herein.

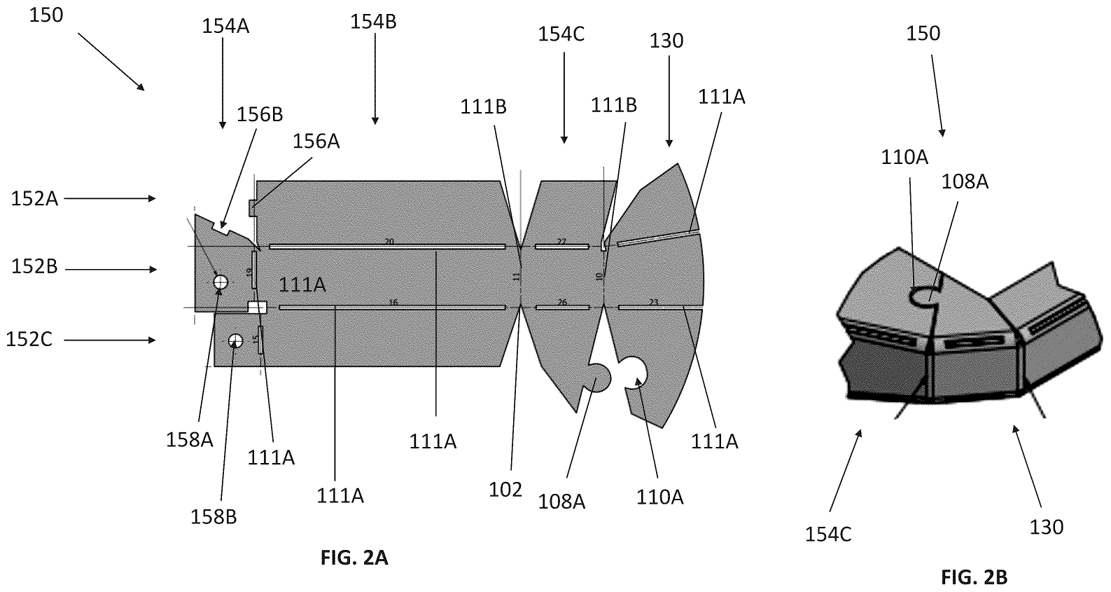

FIG. 2A is an enlarged view of the outer section 150 and shows the outer section 150 in its unfolded configuration. FIG. 2B is an enlarged view of the outer section 150 in its folded configuration. As shown, the outer section 150 is divided into three longitudinal portions 152A, 152B, and 152C, and also into three transverse portions 154A, 154B, and 154C. The right side of FIG. 2 shows the end of the intermediate section 130 that is adjacent to the outer section 150. The longitudinal portions 152A-152C extend generally parallel to an axis that extends along the panel 100 between the outer section 150 and the central section 120, while the transverse portions 154A-154C extend generally perpendicular to this axis. As can be seen, each longitudinal portion is formed from a plurality of transverse sections and each transverse section is formed from a plurality of longitudinal sections, such that the outer section 150 is essentially divided into a 3×3 grid.

Each of the portions is separated from adjacent portions by a slot 111A and/or a perforation line 111B, to allow the outer section 150 to be folded as needed. In the illustrated implementations, longitudinal portions 152A and 152B are separated from each other by slot 111A, and longitudinal portions 152B and 152C are separated from each other by slots 111A. Transverse portions 154A and 154B are separated by slots 111A, and transverse portions 154B and 154C are separated by a perforation line 111B. Transverse portion 154C is separated from the intermediate section 130 by a perforation line 111B. The end of the intermediate section 130 that is immediately adjacent to transverse portion 154C is also separated into three different longitudinal portions, each separated by a slot 111A. In other implementations, these different portions of the outer section 150 could be separated by the other of the slot 111A and the perforation line 111B.

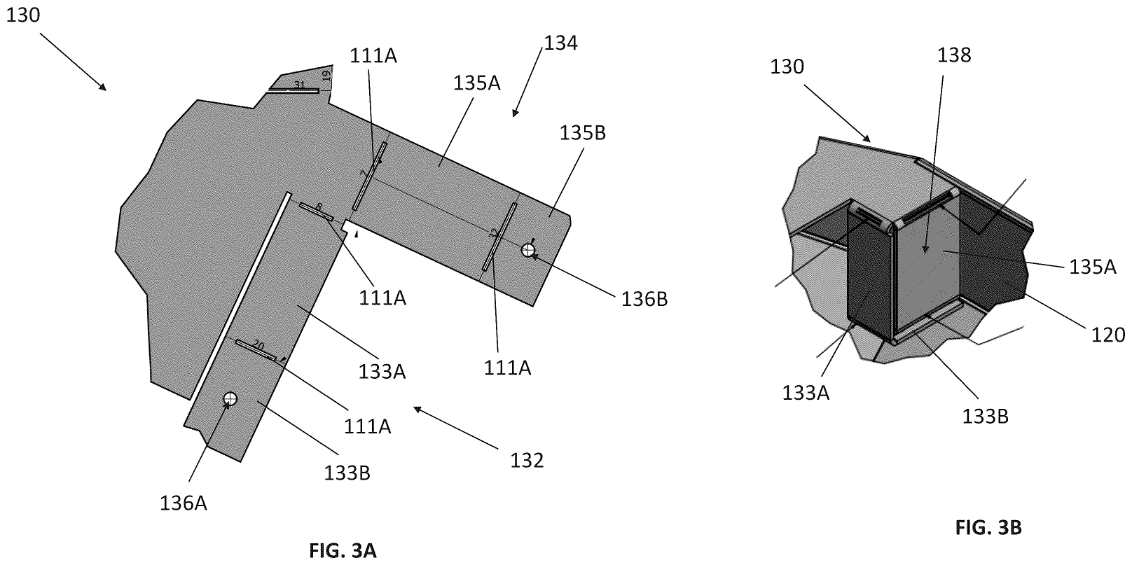

Transverse portion 154C also includes an arc-shaped tab 108A, while the edge of the intermediate section 130 includes an arc-shaped tab receiver 110A. When the panel 100 is in its folded configuration, tab receiver 110A of the intermediate section 130 receives the tab 108A of transverse portion 154C to interlock the transverse portion 154C and the intermediate section 130 in the folded configuration (shown in FIG. 3), which aids in retaining the panel 100 in its folded configuration. The outer sections 150 can also include separate rectangular tabs 156A and corresponding rectangular tab receivers 156B. As shown in FIG. 2A, a tab 156A can be formed on the area of the outer section 150 where the longitudinal portion 152A and the transverse portion 154B intersect, and the tab receiver 156B is defined in the area of the outer section where the longitudinal portion 152A and the transverse portion 154A intersect. The tab 156A can be received within the tab receiver 156B, which aids in retaining the panel 100 in its folded configuration. However, due to the rectangular shape of the tab 156A and the tab receiver 156B, the mating of the two does not provide as much retaining force as the dovetail tabs 108A, 108B and the dovetail tab receivers 110A, 110B. Thus, the rectangular tabs 156A and tab receivers 156B can be used at parts of the panel 100 where less force is required. For example, portions of the panel 100 where two surfaces of the panel meet at a right angle generally require less force to be held together as compared to two co-planar surface of the panel 100 meeting, as there is little or no force (for example due to the inherent nature of the material to resist bending) pulling apart the surfaces meeting at a right angle. Thus, the tab 156A and the tab receiver 156B can be used to aid in retaining the surfaces together.

Finally, the outer section 150 also includes two bolt holes 158A and 158B. Bolt hole 158A is formed in the part of the panel 100 where the longitudinal portion 152B and the transverse portion 154A intersect, while bolt hole 158B is formed in the part of the panel 100 where the longitudinal portion 152C and the transverse portion 154A intersect. The bolt holes 158A and 158B facilitate alignment of the panel 100 and allow for fastening of the different portions of the outer section 150 to increase the structural rigidity of the panel 100 in its folded configuration.

The panel 100 is generally symmetric and the outer section 160 has the same configuration as the outer section 150. In the illustrated implementation, the outer section 160 includes the trapezoid-shaped tab 108B and the intermediate section 140 includes the trapezoid-shaped tab receiver 110B, instead of the arc-shaped tab and tab-receivers 108A and 108B. However, the intermediate sections 130 and 140 and the outer section 150 and 160 can all have any suitable shape of tab and tab receiver to interlock the sections as necessary. While FIGS. 2A and 2B show the outer section 150, the outer section 160 can have generally the same design.

FIG. 3A is an enlarged view of a portion of the intermediate section 130, and shows the intermediate section 130 in its unfolded configuration. As shown in FIG. 3A, the intermediate section 130 includes two flaps 132 and 134 that are formed on the side of the intermediate section 130 nearest to the central section 120. Each of the flaps is formed from multiple portions that are foldable relative to each other. The flap 132 is formed from a proximal portion 133A and a distal portion 133B, while the flap 134 is formed from a proximal portion 135A and a distal portion 135B. The proximal portions 133A and 135A are integrally formed with the rest of the intermediate section 130 and are separated from the rest of the intermediate section 130 by slots 111A. The distal portion 133B is separated from the proximal portion 133A by a slot 111A, and the distal portion 135B is separated from the proximal portion 135A by a slot 111A. The intermediate section 130 also includes bolt hole 136A formed in the distal portion 133B of flap 132, and bolt hole 136B formed in the distal portion 135B of flap 134. The bolt holes 136A and 136B can be used to secure the flaps 132 and 134 to the central section 120 when the panel 100 is in the folded configuration.

FIG. 3B is an enlarged view of the intermediate section 130 in its folded configuration showing the flaps 132 and 134 folded to form a multi-sided mounting bracket 138, which can be used to attach the panel 100 in its folded configuration to a vehicle. As shown, the proximal portions 133A and 135A of the flaps 132 and 134 will generally extend from the intermediate section 130 to the central section 120, with the distal portions 133B and 135B (not visible in FIG. 3B) folded under each other. Each of the distal portions 133B and 133B overlaps with both part of the intermediate section 130 and the central section 120. A bolt can be inserted through the bolt holes 136A and 136B to secure the flaps 132 and 134. While FIGS. 3A and 3B show the intermediate section 130, the intermediate section 140 can have generally the same design.

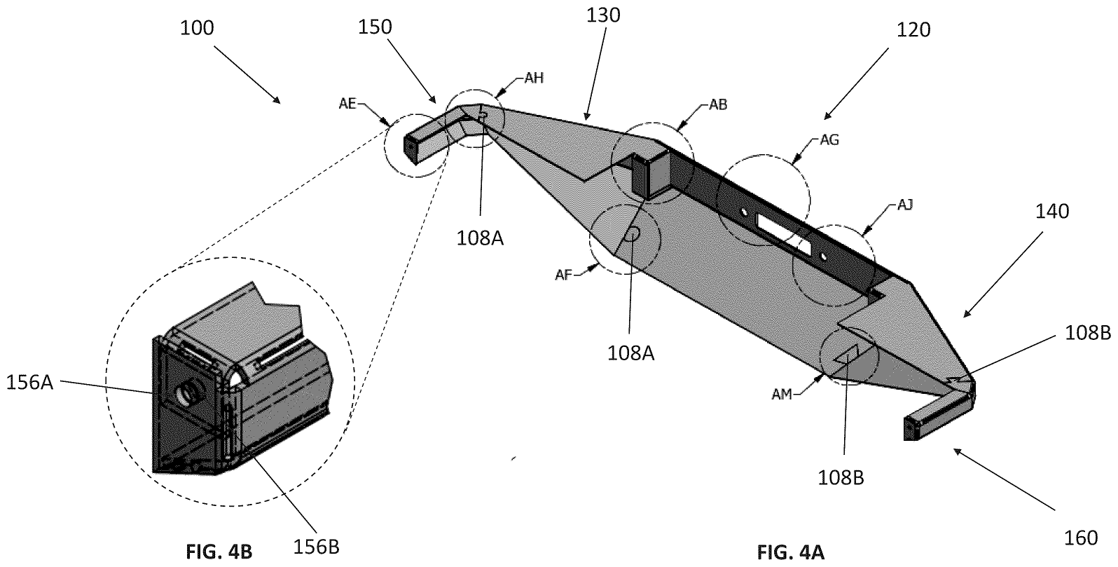

FIG. 4 illustrates a vehicle bumper that is formed when the structural panel 100 is in its folded and interlocked configuration. As shown, the central section 120 is folded to form the front and bottom of the bumper, and includes a front surface and a lower surface. The intermediate sections 130 and 140 are folded to form top, front, and bottom sides of the bumper, and each include an upper surface, a front surface, and a lower surface. The outer sections 150 and 160 are folded to form tubes having top, bottom, and (outer) side surfaces. As shown, the tubes formed by the outer sections 150 and 160 extend generally perpendicular to an axis extending along the central section 120 and the intermediate sections 130 and 140. Thus, the central section 120 and the intermediate section 130 and 140 form a front portion of the vehicle bumper, while the outer sections 150 and 160 form perpendicularly-extending wings that can be attached to the vehicle. In some implementations, any one or more of the central section 120, the intermediate section 130, or the intermediate section 140 can also be attached to the vehicle.

As shown, the flaps 132 and 134 of each of the intermediate sections aid in adding structural rigidity to the panel 100 in its folded configuration. Each of the intermediate sections 130 and 140 forms both a top surface and a bottom surface when folded. The flaps 132 and 134 of each respective intermediate section fold to form a vertical wall that extends between (i) the top surface of the respective intermediate section, and (ii) the bottom surface of the respective intermediate section and/or a bottom surface formed by the central section. Thus, the proximal portions of the flaps 132 and 134 of each respective intermediate section are integrally formed with the upper surface of the respective intermediate section. The distal portions of the flaps 132 and 134 fold under themselves. The distal portions of the flaps 132 and 134 of the first intermediate section 130 overlap with the lower surface of the central section 120 and the lower surface of the first intermediate section 130. The distal portions of the flaps 132 and 134 of the second intermediate section 140 overlap with the lower surface of the central section 120 and the lower surface of the second intermediate section 140. Bolts can be inserted through the bolt holes defined in the distal portions of the flaps, which aids in securing the panel 100 in the folded configuration and increases the structural rigidity. Thus, the vertical wall formed by the first intermediate section 130 in its folded configuration is integrally formed with the upper surface of the first intermediate section 130, and is attachable to the lower surface of the first intermediate section 130 and the lower surface of the central section 120. The vertical wall formed by the second intermediate section 140 in its folded configuration is integrally formed with the upper surface of the second intermediate section 140, and is attachable to the lower surface of the second intermediate section 140 and the lower surface of the central section 120.

FIG. 4A also shows how the tabs 108A and 108B of the intermediate sections 130 and 140 and the outer sections 150 and 160 are received in the corresponding tab receivers to hold the folded sections together. FIG. 4B is a zoomed-in inset view shows the end of the outer section 150. As shown, the bolt hole 158A and the bolt hole 158B line up when the panel 100 is folded to form the bumper 200. A bolt can be inserted through the bolt holes 158A and 158B to aid in attaching the bumper 200 to a vehicle, and to aid in fastening together the different portions of the outer section 150 and increase the structural rigidity of the panel 100 in its folded configuration.

To assemble the bumper, the panel 100 is first provided. A noted herein, the panel 100 includes a plurality of sections that are integrally formed together, so that the panel 100 is a single piece of material. Next, the panel 100 is folded along the plurality of intended bend lines of the panel 100 to convert the panel 100 to its folded configuration. Then, any adjacent pairs of panels with a tab and corresponding tab receiver can be secured together by inserting the tab into the tab receiver. Any adjacent pairs of panels with overlapping bolt holes can be secured together by inserting a bolt through the overlapping bolt holes. Similarly, any panel that itself has multiple overlapping bolt holes can be secured by inserting a bolt through the overlapping bolts holes.

The present disclosure provides slots and perforations to reduce bending force as well as a single piece panel formed in to bumper via folding by human hand that does not require specialized machinery or large amounts of force. Other novel features of the current disclosure include forming a single piece panel transformed into a fabricated formed component for vehicles, integral mounting brackets, slots dimensioned for fillet welding post folding, interlocking fixturing dovetail shapes, partially boxed sections, and integral bolt holes for structural reinforcement.

Force estimates herein may be examined pursuant to ASTM E290—Standard Test Methods for Bend Testing of Material for Ductility. The force necessary to manipulate the parts of the current disclosure is dependent on the length of the bend element and the material properties and thickness. As a representative, a commercial OEM bumper, based on typical thickness and typical material properties, would require 723 pounds of force to bend their product. Products of the current disclosure require much less and are consistently designed to require bend forces of 50 pounds or less.

While the panel 100 forms a vehicle bumper in the folded configuration, a panel according to the present disclosure can be used to form any suitable component or device when in its folded configuration, including other structural elements of a vehicle (such as a grill guard or a skid plate), and structural elements of machines or objects other than vehicles. Similar, the methods disclosed herein for forming a vehicle bumper from the panel 100 are generally applicably to any such panel that is used to form other components or devices, so long as the panel can includes one or more slots and/or one or more perforations along one or more intended bend lines, and can be secured together using any one or more of the features discussed herein.

Thus, a panel according to the present disclosure can include a plurality of sections integrally formed together as a single piece of material. The panel is foldable along one or more intended bend lines, and can include a slot and/or a perforation defined in the panel along any of the one or more intended bend lines. Any section of the panel may include a tab (dovetail-shaped like an arc-shape or a trapezoid shape, or non-dovetail-shaped like a rectangular shape or a square shape) that is configured to be received with a corresponding-shaped tab receiver in the same section of the panel or an adjacent section of the panel. Any section of the panel may include a bolt hole defined therein. To assembly a structural element of the vehicle, the panel can be folded to convert it from an unfolded or flat configuration, to a folded configuration. The panel can be secured in the folded configuration by inserting any tabs of the panel into the corresponding tab receiver, inserting a bolt through overlapping bolt holes defined in an adjacent pair of section, inserting a bolt through overlapping bolt holes defined in one section, or any combination thereof.

One or more elements or aspects or steps, or any portion(s) thereof, from one or more of any of claims can be combined with one or more elements or aspects or steps, or any portion(s) thereof, from one or more of any of the other claims or combinations thereof, to form one or more additional implementations and/or claims of the present disclosure.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

While the present disclosure has been described with reference to one or more particular embodiments, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations according to aspects of the present disclosure may combine any number of features from any of the implementations described herein.

What is claimed is:

1. A panel that is configured to be converted from a generally flat configuration to a folded configuration to form a structural element of a vehicle, the panel comprising:
a central section;
a first intermediate section and a second intermediate section formed on opposite sides of the central section, the first intermediate section and the second intermediate section being foldable relative to the central section;
a first outer section formed on a side of the first intermediate section opposite from the central section, the first outer section being foldable relative to the first intermediate section; and
a second outer section formed on a side of the second intermediate section opposite from the central section, the second outer section being foldable relative to the second intermediate section,
wherein the panel is configured to be folded along a plurality of intended bend lines to be converted to the folded configuration, and wherein the panel includes a slot or a perforation line defined therein along at least one of intended bend lines.

2. The panel of claim 1, wherein the structural element formed by the panel in the folded configuration is a bumper, a grill guard, or a skid plate.

3. The panel of claim 1, wherein one of the plurality of intended bend lines is located at each intersection between adjacent sections of the panel.

4. The panel of claim 3, wherein (i) one of the slots is defined in the panel at the intended bend line located at an intersection between a first set of adjacent sections of the panel, (ii) one of the perforation lines is defined in the panel at the intended bend line located at an intersection between a second set of adjacent sections of the panel, or (iii) both (i) and (ii).

5. The panel of claim 1, the central section is configured to be folded relative to itself along one or more intended bend lines of the plurality of intended bend lines.

6. The panel of claim 5, wherein one of the slots or one of the perforation lines is defined in the central section of the panel along each of the one or more intended bend lines of the central section.

7. The panel of claim 1, the central section is configured to be folded relative to itself along one or more of the plurality of intended bend lines.

8. The panel of claim 7, wherein one of the slots or one of the perforation lines is defined in the central section of the panel along each of the one or more intended bend lines of the central section.

9. The panel of claim 1, the central section is configured to be folded relative to itself along one or more of the plurality of intended bend lines.

10. The panel of claim 9, wherein one of the slots or one of the perforation lines is defined in the central section of the panel along each of the one or more intended bend lines of the central section.

11. The panel of claim 1, wherein when the panel is in the folded configuration, the first outer section and the second outer section each form a tube that extends perpendicular to an axis extending between the central section, the first intermediate section, and the second intermediate section.

12. The panel of claim 11, wherein the tubes formed by the first outer section and the second outer section are attachable to the vehicle via bolt holes defined in the first outer section and the second outer section.

13. The panel of claim 1, wherein the first intermediate section and the second intermediate section each include a pair of foldable flaps, each of the foldable flaps being formed from multiple portions that are foldable relative to each other.

14. The panel of claim 13, wherein when the panel is in the folded configuration, the first intermediate section is folded to include an upper surface and a lower surface, and the pair of flaps of the first intermediate section are folded to form a vertical wall extending between the upper and lower surfaces of the first intermediate section.

15. The panel of claim 14, wherein when the panel is in the folded configuration, the second intermediate section is folded to include an upper surface and a lower surface, and the pair of flaps of the second intermediate section are folded to form a vertical wall extending between the upper and lower surfaces of the second intermediate section.

16. The panel of claim 15, wherein when the panel is in the folded configuration, the central section is folded to include a lower surface, and wherein:
the vertical wall of the first intermediate section is integrally formed with the upper surface of the first intermediate section, and is attachable to the lower surface of the first intermediate section and the lower surface of the central section; and
the vertical wall of the second intermediate section is integrally formed with the upper surface of the second intermediate section, and is attachable to the lower surface of the second intermediate section and the lower surface of the central section.

17. The panel of claim 1, further comprising a tab extending from at least one of the sections of the panel and a tab receiver defined in an adjacent section of the panel, wherein when the panel is in its folded configuration, the tab receiver of the at least one receives the tab of the adjacent section therein.

18. The panel of claim 17, wherein the tab has a shape corresponding to the tab receiver and a maximum dimension that is larger than a width of an opening of the tab receiver.

19. The panel of claim 17, wherein the shape of the tab is a trapezoid shape, an arc shape, a rectangular shape, or a square shape.

20. A method of assembling a structural element, the method comprising:
providing a panel including a plurality of sections integrally formed together as a single piece of material, the panel being foldable along a plurality of intended being lines, the panel including a slot or a perforation defined therein along at least one of the plurality of intended bend lines.
folding the panel along the plurality of intended bend lines to convert the panel to a folded configuration;
securing the panel in its folded configuration by:
(i) inserting a tab of one section into a tab receiver defined in another section;
(ii) inserting a first bolt through overlapping bolt holes defined in an adjacent pair of sections;
(iii) inserting a second bolt through overlapping bolt holes defined in one section; or
(iv) any combination of (i)-(iii).
